(19) United States
(12) Patent Application Publication
(10) Pub. No.: US 2005/0197807 A1
(43) Pub. Date: Sep. 8, 2005

(54) System and method for maintaining homogeneity between a model in a computer-aided modeling system and corresponding model documentation

(76) Inventors: Jerimy Nelson, Fort Collins, CO (US); Mark D. Frank, Longmont, CO (US); Karl Bois, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/793,533

(22) Filed: Mar. 4, 2004

(51) Int. Cl. G06F 19/00; G05B 19/42; G06F 17/50

(52) U.S. Cl. 703/1; 700/97; 715/700; 716/1

(57) ABSTRACT

According to at least one embodiment, a system comprises logic for maintaining homogeneity between a model of an object designed in a computer-aided modeling system and corresponding parameter information for the model included in a model documentation file.

### BACKGROUND

Computer-aided design (CAD) programs are commonly used for designing and modeling electronic devices, such as integrated circuits, printed circuit boards, microelectromechanical systems (MEMS), and nanoelectromechanical systems (NEMS). An example of such a CAD program is the Advanced Package Designer (APD) System available from Cadence Design Systems, Inc. The APD system provides an environment for modeling of high-speed, high-density integrated circuit packages, multiple modules, and hybrids for analysis thereof. This environment provides a framework for integrated circuit integration, physical layout, package modeling, interconnect routing, and analysis. The Allegro® printed circuit board (PCB) layout system, which is also available from Cadence Design Systems, Inc., provides an interactive environment for designing complex and/or high-speed, multi-layer printed circuit boards.

CAD programs commonly handle such tasks as circuit synthesis, simulation, layout generation, and layout verification. CAD programs generally include an interface for receiving various parameters for a desired design from a user and for outputting a representation of the resulting design to the user (e.g., as a schematic diagram and/or a netlist). Such CAD programs may further include a simulator for simulating the operation of a design. Accordingly, CAD programs aid a developer in visualizing and analyzing an electronic design or “model” as well as its operation.

In defining a model for an object in a computer-aided modeling system (e.g., a CAD program), such as an electrical circuit, users often maintain model documentation that describes various parameters used in the model. For instance, for an electrical model a designer typically maintains model documentation that includes information identifying such parameters as physical dimensions of various portions of the electrical model (e.g., for various components, sub-circuits, cross-sections, etc.) and electrical characteristics (resistivity, etc.) of various portions of the model. Traditionally, as changes are made to a model, designers are required to manually update its corresponding documentation to reflect the changes. This leads to inefficiencies in model design and analysis because a designer is required to spend time manually updating the model documentation as changes are made to the model. Further, because designers are required to manually maintain the model documentation, from time-to-time designers may fail to update the model documentation to reflect a change made to the model or incorrect information may be mistakenly entered into the documentation. Accordingly, the model documentation may not accurately reflect the corresponding model design.

### SUMMARY

According to at least one embodiment, a system comprises logic for maintaining homogeneity between a model of an object designed in a computer-aided modeling system and corresponding parameter information for the model included in a model documentation file.

### BRIEF DESCRIPTION OF THE DRAWINGS

FIG. 1 shows an example of one embodiment of a system that includes a model documentation engine operable to update the corresponding model documentation consistent with its model in a computer-aided modeling system;

FIGS. 2A and 2B show an example model documentation file that is maintained for a model designed in a computer-aided modeling system according to one embodiment;

FIG. 3 shows an operational flow diagram for one embodiment of FIG. 1;

FIG. 4 shows an example of one embodiment of a system that includes a dynamic model revision engine operable to update the corresponding model in a computer-aided modeling system to be consistent with its model documentation;

FIG. 5 shows an operational flow diagram for one embodiment of FIG. 4;

FIG. 6 shows an example of one embodiment of a system that includes a sub-circuit generation engine operable to generate a sub-circuit file based on information included in a model documentation file for use by a computer-aided modeling system;

FIG. 7A shows an example operational flow for generating a sub-circuit file in accordance with one embodiment;

FIG. 7B shows an operational flow diagram for one embodiment of FIG. 6;

FIG. 8 shows an example system that includes the model documentation engine of FIGS. 1-3, the dynamic model revision engine of FIGS. 4-5, aid the sub-circuit generation engine of FIGS. 6-7;

FIGS. 9A and 9B show operational flows according to various embodiments of a system for maintaining homogeneity between a model in a computer-aided modeling system and its corresponding model documentation;

FIG. 9C shows an operational flow according to various embodiments of a system for creating sub-circuit files; and

FIG. 10 shows an example computer system adapted according to an embodiment of implementing one or more of the engines described in connection with FIGS. 1-9C.

### DETAILED DESCRIPTION OF THE INVENTION

Various embodiments of systems and methods are described herein for efficiently maintaining homogeneity between a model in a computer-aided modeling system and the model's corresponding documentation. That is, embodiments are provided for maintaining accuracy between the information in the model documentation and the corresponding model in a computer-aided modeling system. More specifically, various engines are described that are operable to autonomously maintain homogeneity between a model and that model's corresponding documentation. In this sense, the engines enable the model and that model's corresponding documentation to have homogeneous parameters such that both the model and its corresponding documentation reflect the same parameter values for the model. For instance, in certain embodiments an engine monitors a model's design in a computer-aided modeling system, and responsive to changes made to the model (e.g., to one or more of its parameters) in the computer-aided modeling system the engine autonomously edits the corresponding documentation to the model to reflect those changes. Further, in certain embodiments an engine monitors the documentation file for a model, and responsive to edits made to the documentation file (e.g., to one or more of the parameters specified therein) the engine autonomously changes the corresponding model in the computer-aided modeling system to reflect those changes.

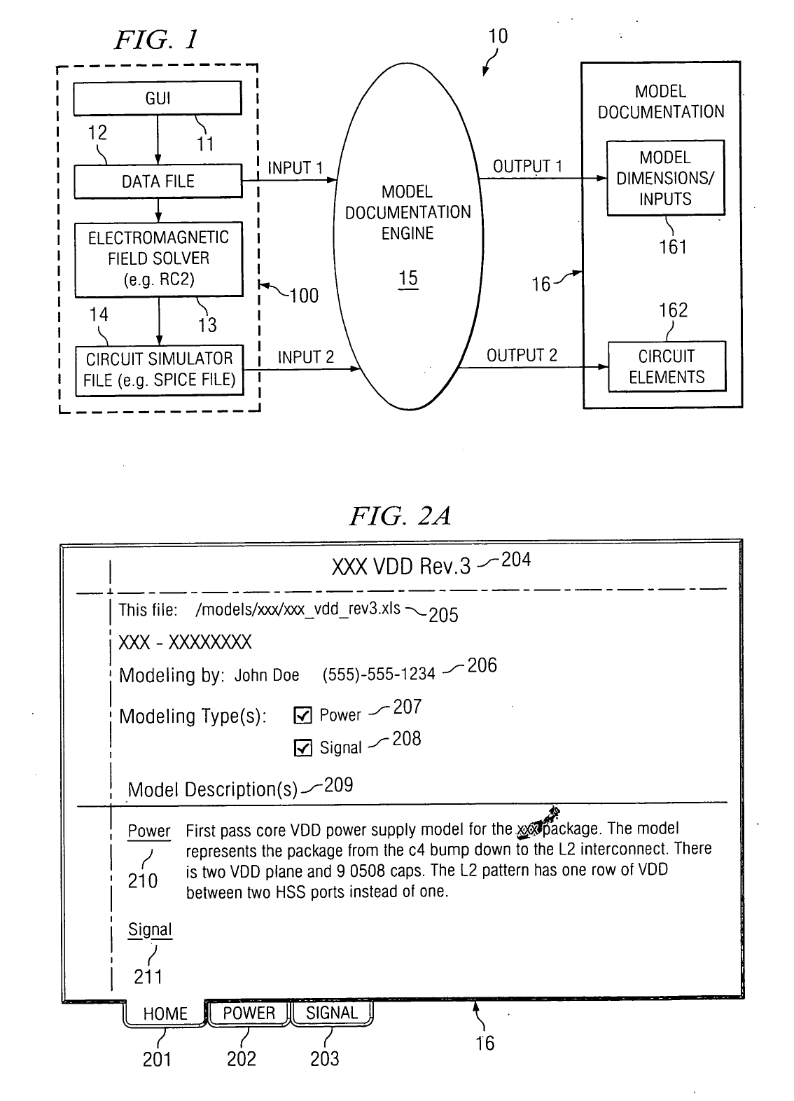

As described further below in connection with FIGS. 1-3, in certain embodiments, a model documentation engine is implemented to autonomously generate model documentation for a model of an object, such as a model of an electrical circuit, that is designed in a computer-aided modeling system. Thus, such model documentation engine aids in efficiently maintaining the model documentation file with accurate information (e.g., accurate parameter values) corresponding to the designed model. Accordingly, when the model is changed in the computer-aided modeling system, the engine autonomously updates the model documentation file to reflect the changed model.

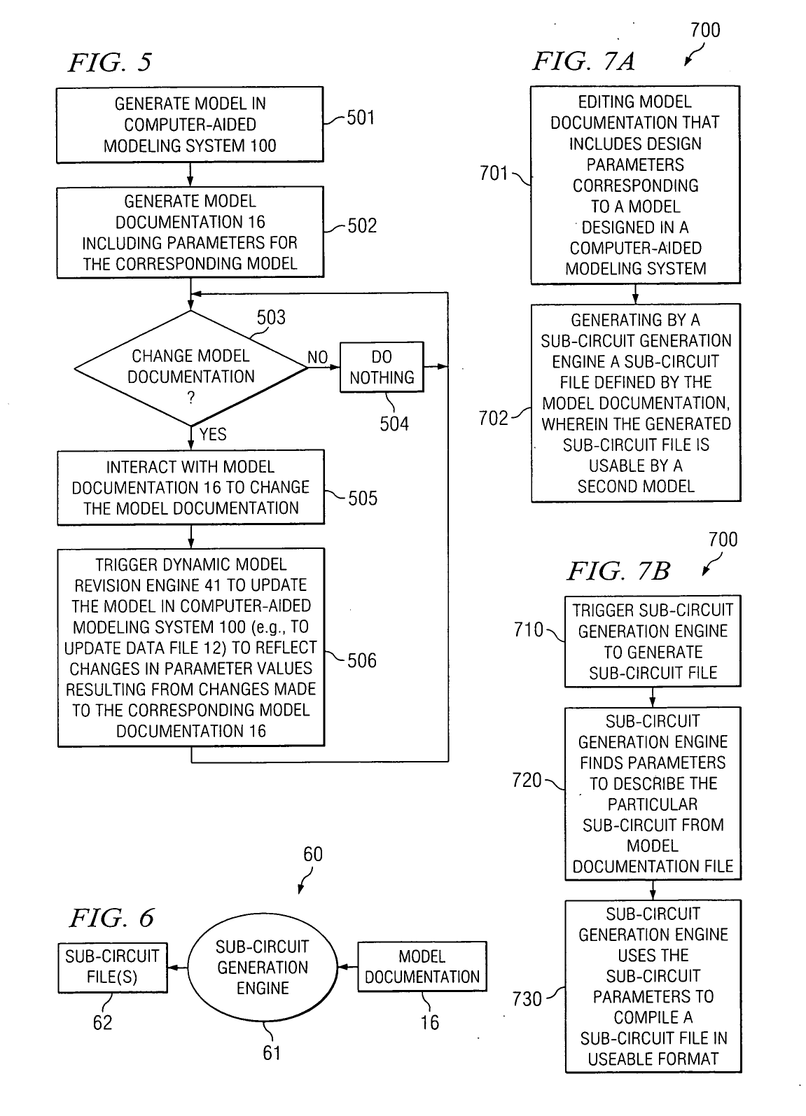

As described further below in connection with FIGS. 4-5, in certain embodiments, a dynamic model revision engine is implemented to generate changes in a model designed in a computer-aided modeling system responsive to editing of the model's corresponding documentation file. Thus, if a designer changes a parameter of the model in the model's documentation file, the dynamic model revision engine causes such change to be made to the actual designed model in the computer-aided modeling system without the designer being required to change the parameter in both the model documentation and the actual model design itself. Accordingly, such dynamic model revision engine aids in efficiently maintaining the designed model consistent with its documentation file.

As described further below in connection with FIGS. 6-7, in certain embodiments, a sub-circuit generation engine is implemented to generate a sub-circuit file in a computer-aided modeling system responsive to triggering. The generated sub-circuit file is basically a circuit simulator file reformatted (possibly with additional notes or variables) to fit a corresponding application (e.g., a SPICE deck) and usually makes up part of a larger circuit model. This sub-circuit file may be stored for use in future models. Thus, if a designer changes parameters of a sub-circuit in a model's documentation file to effectively create a new sub-circuit, the sub-circuit generation engine generates a new sub-circuit file.

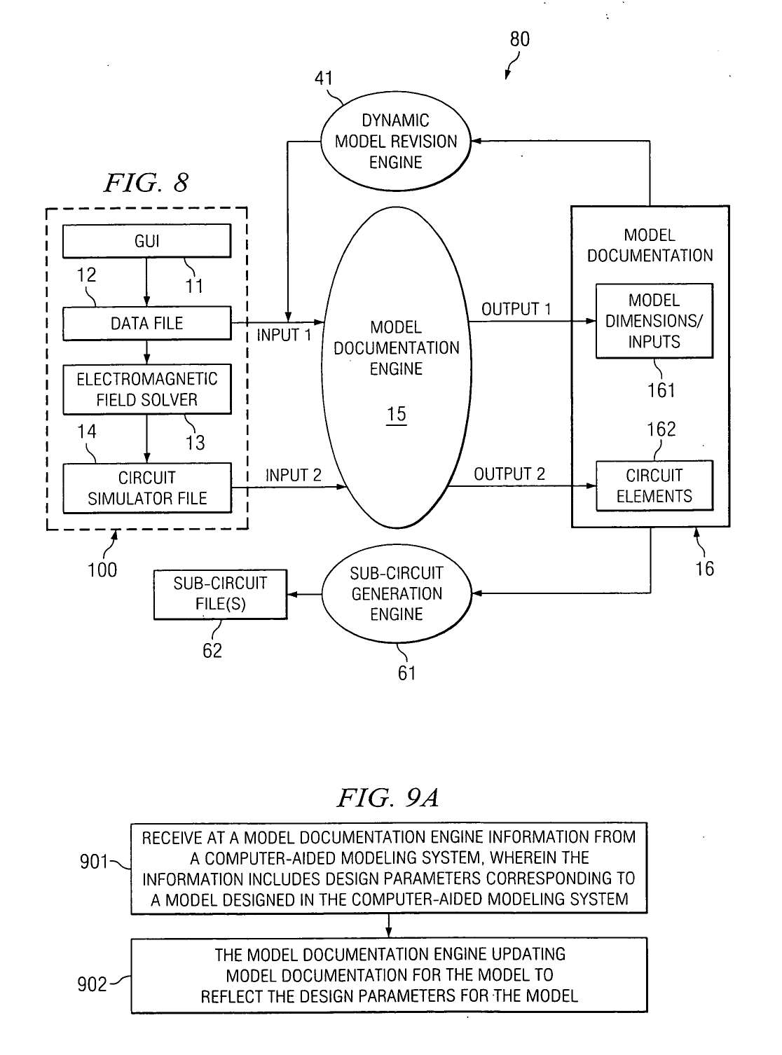

The functionality of any combination of the engines described in FIGS. 1-7 may be implemented in certain embodiments. For instance, an example system that includes the model documentation engine of FIGS. 1-3, the dynamic model revision engine of FIGS. 4-5, and the sub-circuit generation engine of FIGS. 6-7 is described below in connection with FIG. 8.

Turning to FIG. 1, an example of one embodiment of a system 10 is shown. System 10 includes a computer-aided modeling system 100 for modeling an object, such as the computer-aided modeling system commercially known as Ansoft HSS for modeling electrical systems. In this example, computer-aided modeling system 100 includes a graphical user interface (“GUI”) 11 for interacting with a user to receive input information defining the model and/or to output information to the user concerning the model. For instance, a designer may input various parameters for the model via GUI 11. GUI 11 typically allows a user to draw various components for the model (or select them from a library/database of components) and/or input associated characteristics of the components, such as their size, type of material, electrical characteristics, etc. Typically, a user defines various two-dimensional (“ 2D”) cross-sections of an electrical system that when combined define the full electrical system being modeled. As an example, in defining an electrical trace that is included within the middle of a circuit board in an electrical model, a designer may draw three stacked rectangles to represent a 2D cross-section of two dielectric materials sandwiching a metal conductor (the electrical trace). The designer may interact with GUI 11 further to assign values for the resistivity of the metal (the middle rectangle), as well as the dielectric constants for each of the other two rectangles.

The computer-aided modeling system 100 uses the received input to generate a data file 12 for the model. Data file 12 which is often referred to as a netlist, is usually a very concise file that includes parameters defining the model. For an electrical model, for example, data file 12 may list the various elements of the model (such as each of the three rectangles in the above example) and identify for each element its type (e.g., whether it is a conductor or a dielectric, etc.), its geometry (e.g., its shape and size), and its position in the 2D cross-section.

Computer-aided modeling system 100 illustrates an example system for modeling an electronic system, and therefore it includes an electromagnetic field solver 13, such as SPICELINK2D available from Ansoft or RAPHAEL RC2 available from Avant!. In this example, electromagnetic field solver 13 receives the information from data file 12 (the 2D cross-sectional information) and translates that into circuit simulator file 14, such as a SPICE circuit simulator file (SPICE is a general-purpose circuit simulation program), having the resistance, inductance, and capacitance of the corresponding cross-section scaled to the length of the cross-section. Accordingly, electromagnetic field solver 13 generates circuit simulator file 14, which may be suitable for use by a simulator program to simulate the operation of the model, such as a SPICE file for use by a SPICE circuit simulator program. Again, computer-aided modeling system 100 may be any suitable modeling system now known or later developed, including without limitation CAD systems that are known for modeling electrical systems in the manner briefly described above.

Further included in system 10 is model documentation engine 15. Model documentation engine 15 includes logic (software and/or hardware) that is operable to maintain the corresponding model documentation, such as model documentation file 16, consistent with its model designed in computer-aided design system 100. In certain embodiments, model documentation engine 15 is operable to generate model documentation file 16 and/or update such model documentation file 16 to accurately reflect information for the corresponding model designed in computer-aided modeling system 100.

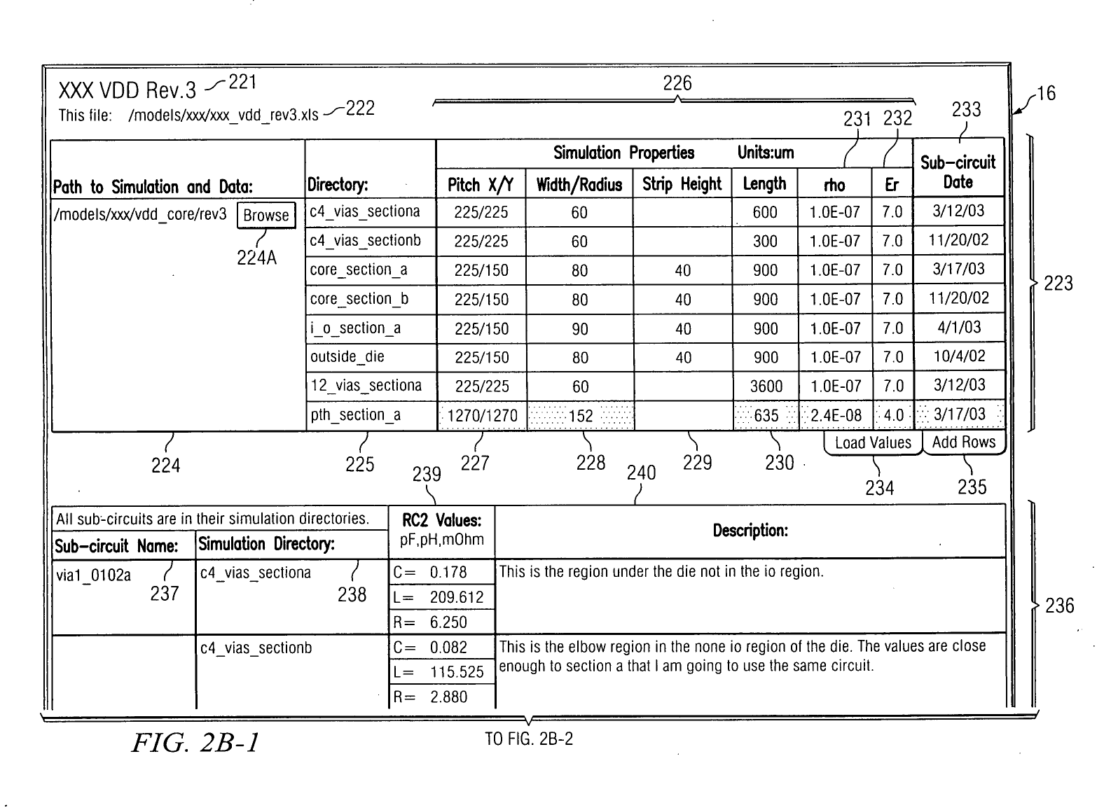

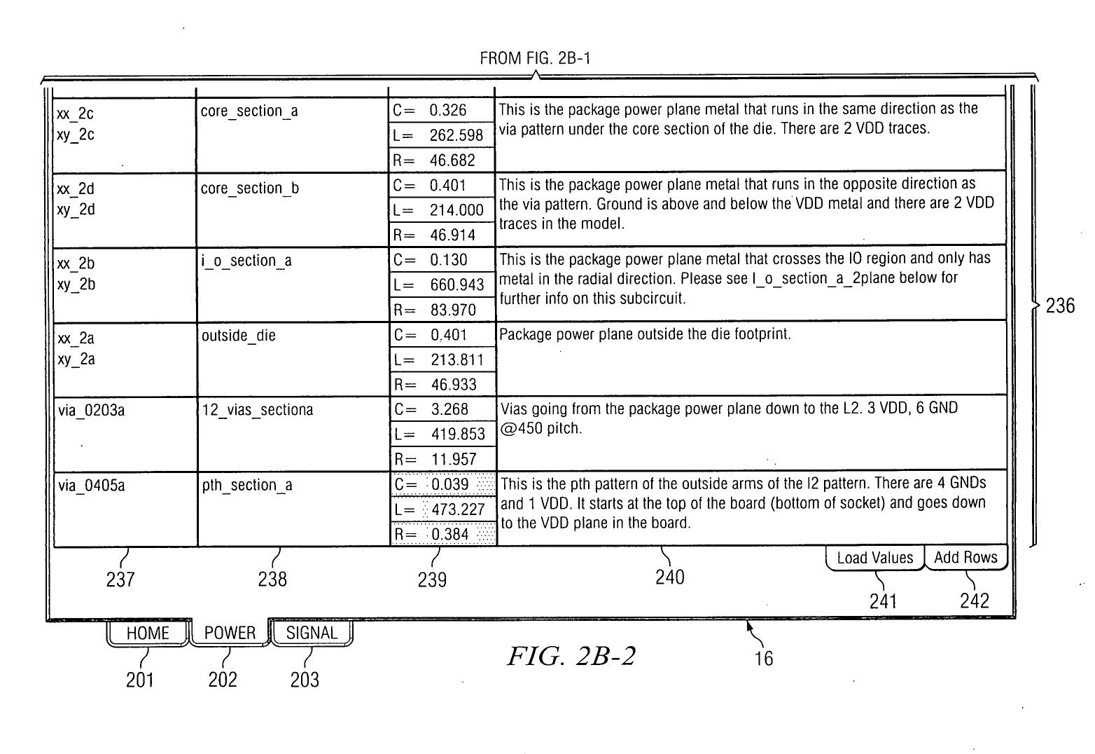

In the example of FIG. 1, model documentation engine 15 is operable to generate model documentation 16 for the corresponding model designed in computer-aided modeling system 100. In operation, model documentation engine 15 receives information, labeled “input 1,” from data file 12. Model documentation engine 15 also receives information, labeled “input 2,” from circuit simulator file (e.g., SPICE file) 14. From this received information, model documentation engine 15 generates various parameter information for documenting the corresponding model in documentation file 16. In this example, model documentation engine 15 generates “output 1” for supplying model dimensions/inputs information 161 to model documentation file 16, and model documentation engine 15 generates “output 2” for supplying circuit elements information 162 to model documentation file 16. Model dimensions/inputs information 161 and circuit elements information 162 are described further below in conjunction with the example model documentation file of FIGS. 2A-2C.

Turning to FIGS. 2A and 2B, an example model documentation file 16 that is generated by one embodiment of model documentation engine 15 is shown. In this example, model documentation file 16 is an Excel spreadsheet file, but in other implementations model documentation engine 15 may generate any other suitable type of documentation file, including without limitation a file for any type of spreadsheet application, a file for any type of word processing application, a plain text file, etc.

Model documentation file 16 may be used for any modeling scheme, including a scheme in which signal modeling and power modeling are conceptually separated. The example model documentation file 16 of FIGS. 2A and 2B is used for such a scheme, such that signal modeling and power supply modeling of an electrical model are represented as separate modeling types. Accordingly, in the example of FIGS. 2A and 2B, model documentation file 16 includes three (3) sections (or pages). A first section, referred to as “Home,” is viewable by selecting tab 201. The second section, referred to as “Power,” is viewable by selecting tab 202, and the third section, referred to as “Signal,” is viewable by selecting tab 203. FIG. 2A shows the “Home” page that is presented responsive to a user selecting tab 201. FIG. 2B shows the “Power” page that is presented responsive to a user selecting tab 202, and which is similar in layout and operation to the “Signal” page (not shown). Other modeling schemes may be the subject of model documentation file 16, such as a scheme in which all modeling is represented together on one page. Any kind of circuit modeling scheme is within the scope of embodiments.

As shown in FIG. 2A, the Home page provides general information regarding the corresponding model, such as the designer(s) (field 206) performing this modeling as well as contact information for the designer (e.g., the designer's telephone number, email address, etc.) and brief descriptions of the models (section 209 including fields 210 and 211). In this example, the information presented by the Home page is entered manually by a user. However, alternate embodiments may employ automated population of the Home page by, for example, accessing a file containing such information and entering that information into various fields.

More specifically, for the example of FIG. 2A, Home page 201 includes a name 204 of the model, which in this example is “XXX VDD Rev. 3”. Home page 201 further includes identification of the location 205 of this documentation file 16 and/or the file location of the corresponding model (e.g., the location of the corresponding circuit simulator file 14 and/or data file 12). In this example, the location 205 of this model documentation file is identified as “/models/xxx/xxx vdd_rev3.xls”. As mentioned above, Home page 201 includes identification 206 of the designer(s) performing the modeling, which in this example is “John Doe” having a telephone number (555) 555-1234. Accordingly, anyone reviewing this model documentation 16 desiring to contact the designer performing this modeling may refer to field 206 to determine the appropriate designer(s) to contact.

Home page 201 also includes check boxes 207 and 208 for designating the types of modeling performed for the corresponding model being documented. A designer may customize check boxes (such as 207 and 208) to reflect any kind of modeling scheme, including, but not limited to, the scheme employed in this example in which power modeling and signal modeling are conceptually separated. For instance, “Power” check box 207 identifies whether power supply modeling of an electrical model is performed, and “Signal” check box 208 identifies whether signal modeling of the electrical model is performed. In this example, both power and signal modeling are identified as being performed for the corresponding electrical model.

Model description section 209 is also included, which provides a brief description 210 of the power supply model and a brief description 211 of the signal model. Similar to check boxes 207 and 208, model description section 209 may also be customized to reflect any modeling scheme.

Turning to FIG. 2B, an example section (or page) of the model documentation file 16 that is presented responsive to a user selecting Power tab 202 is shown. This example Power page 202 of FIG. 2B again includes the name 221 of the model, which in this example is “XXX VDD Rev. 3”. Power page 202 again includes identification of the location 222 of this documentation file 16 and/or the file location of the corresponding model (e.g., the location of the corresponding circuit simulator file 14 and/or data file 12). In this example, the location 222 of this model documentation file is identified as “/models/xxx/xxx_vdd_rev3.xls”.

Power page 202 further includes a section 223 that includes certain parameter information for the model, such as the model dimensions/inputs information 161 of FIG. 1. More specifically, section 223 includes information 224 identifying the path to simulation data and data files (e.g., the path to circuit simulator file 14 and data file 12 of FIG. 1). Path information 224 identifies the path for the main directory in which all of the simulation folders 225 are located. As shown, a “Browse” button 224A is provided in this example, which when activated allows a user to search through various directories/paths to locate the desired simulation data for the corresponding model. In this example, the path for the main directory of the simulation data and data files is identified as “/models/xxx/ydd_core/rev3”. In at least one embodiment, the program goes to the main directory identified by information 224 and loads up section 225 with the simulation and data directory names. In these directories are the circuit simulation files 14 and data files 12.

Each of the directories identified in information 225 correspond to a sub-circuit available in the specified path that is included in the model. For instance, “/models/xxx/vdd_core/rev3/C4_vias_sectiona” is one sub-circuit that provides a portion of the simulation data for the model. Within each directory, there may be several files corresponding to cross-sections of the sub-circuit. In this example, there are 8 directories (sub-circuits) identified in the directory information 225 for this model. Sub-circuit date information 233 identifies the creation date or date last modified for the corresponding sub-circuit. For instance, sub-circuit c4_vias_sectiona was last modified (or was created) Mar. 12, 2003 in this example.

Section 223 also includes simulation properties 226 for the corresponding model. For instance, various dimension and/or input parameters are provided for each of the sub-circuits included in the model. In this example, a first parameter is the “Pitch X/Y” information 227, which specifies a grid for the corresponding sub-circuit. For instance, c4_vias_sectiona specifies a pitch of “225/225, ” which indicates that those vias are spaced at multiples of 225 um in the X-direction and 225 um in the Y-direction. Another parameter included in this example is the “Width/Radius” information 228, which specifies a trade width (if height is given) or a via radius, as examples, for the corresponding sub-circuit. Another parameter included in this example is the “Strip Height” information 229, which specifies the trace or strip height for the corresponding sub-circuit. Another parameter included in this example is the “Length” information 230, which specifies the length for the corresponding sub-circuit. Also, included as parameters are electrical characteristics rho 231 and Er (the dielectric constant) 232 for the corresponding sub-circuit. The parameters that may be represented in simulation properties 226 are not limited to the parameters mentioned above. In fact, any helpful parameter may be included.

Tab buttons 234 and 235 are provided for section 223. Tab button 234, when activated by a user, loads the values for the parameters 226 and 233 for the corresponding model in the computer-aided modeling system 100. That is, activating tab button 234 triggers model documentation engine 15 to retrieve the current parameter values for the corresponding model from the computer-aided modeling system 100 and update the appropriate values in section 223. More specifically, in this embodiment, the information for section 223 is retrieved as input 1 from data file 12 by model documentation engine 15. In certain embodiments, this information may be periodically retrieved by model documentation engine 15 and updated in section 223 in addition to or instead of providing load values tab 234 for allowing a user to trigger such updating of the parameter values.

In the example embodiment of FIG. 2B, an indication is provided of any values that have changed since they were last loaded into the documentation file 16. For instance, the changed parameter values may be shown in a different color (e.g., red) from the unchanged parameter values (e.g., black). In the example of FIG. 2B, the parameter values for the sub-circuit “pth_section_a” (the bottom row in section 223) are indicated as having changed since the last time these values were loaded, as such parameter values are shown in a different color (e.g., red) from all of the unchanged parameter values in section 223. In this manner, a designer may easily recognize those parameter values that have changed in the documentation 16 as a result of changes made in the corresponding model. This may be helpful to aid the designer in verifying that those parameter changes are correct, as well as providing notification to the designer that the documentation has been updated to reflect the changes in the corresponding model.

Tab button 235 is also provided which allows a user to add additional rows to the section 223. In at least one embodiment, a user manually enters directories in the rows and the program ensures that necessary formatting and buried notations are saved with the user-entered information. An alternative embodiment may include automated entry of directories such that the program automatically retrieves them from data file 12, creates a row, and enters the information therein.

Power page 202 also includes a section 236 that includes certain parameter information for the model, such as circuit elements information 162 of FIG. 1. More specifically, section 236 specifies electrical characteristics (e.g., capacitance, inductance, and resistance) for the various circuit elements included in the model. In the example of FIG. 2B, section 236 includes sub-circuit name information 237, which identifies one or more sub-circuits included in the model, such as sub-circuit “vial 0102a” and sub-circuit “xx_{—}2c” and xy_{—}2c”. All sub-circuit names that represent the same simulation or calculated values are included in a common section of sub-circuit name information 237. For instance, the names “xx_{—}2c” and “xy 2c” each represent the same simulation or calculated values for the model, and therefore these names are arranged in a common section of sub-circuit name information 237. Simulation directory information 238 identifies the directory for the corresponding sub-circuit name(s) 237. This can include multiple directories if the sub-circuit is calculated using several simulations.

Various electrical parameter values for each sub-circuit in the model are provided in section 239. In this example, section 239 includes the following values (referred to as “RC2” values): capacitance (C), inductance (L), and resistance (R) for the corresponding sub-circuit. For instance, for sub-circuit “vial_{—}0102a” (the first row of section 236), a capacitance of 0.178 pF, an inductance of 209.612 pH, and a resistance of 6.250 mOhm is documented. Also, a description section 240 is included for documenting a description of each of the sub-circuits. In this example, the descriptions are entered manually by a user. Further, information in description section 240 may be placed into the corresponding sub-circuit along with other information.

Tab buttons 241 and 242 are provided for section 236. Tab button 241, when activated by a user, loads the values for the parameters 239 for the corresponding model in the computer-aided modeling system 100. Activating tab button 241 triggers model documentation engine 15 to retrieve the current parameter value, for the corresponding model from the computer-aided modeling system 100 and update the appropriate values in section 236. More specifically, in this embodiment, the information for section 236—is retrieved as input 2 from circuit simulator file 14 by model documentation engine 15. Thus, capacitance, inductance, and resistance values computed by the electromagnetic field solver 13 and stored in the circuit simulator file 14 for each sub-circuit of the model are retrieved by engine 15 and updated in the corresponding fields in section 236 of documentation 16. In certain embodiments, this information may be periodically retrieved by model documentation engine 15 and updated in section 236 in addition to or instead of providing load values tab 241 for allowing a user to trigger such updating of the parameter values. Alternately when directories 225 are loaded (as explained above), the program may load the directory names into simulation directories 238. In this example, sub-circuit names 237 are entered manually by a designer so that the designer may apply names as he wishes.

In the example embodiment of FIG. 2B, an indication is provided of any values that have changed since they were last loaded into the documentation file 16. For instance, the changed parameter values may be shown in a different color (e.g., red) from the unchanged parameter values (e.g., black). In the example of FIG. 2B, the parameter values for the sub-circuit “via 0405a” (the bottom section in section 236) are indicated as having changed since the last time these values were loaded, as such parameter values are shown in a different color (e.g., red) from all of the unchanged parameter values in section 236. In this manner, a designer may easily recognize those parameter values that have changed in the documentation 16 as a result of changes made in the corresponding model. This may be helpful to aid the designer in verifying that those parameter changes are correct, as well as providing notification to the designer that the documentation has been updated to reflect the changes in the corresponding model.

Tab button 242 is also provided which allows a user to add additional rows to the section 236. In at least one embodiment, a user manually adds directories in the new rows and the program ensures that necessary formatting and buried notations are saved with the user-entered information. An alternative embodiment may include automated entry of directories such that the program automatically retrieves them from circuit simulation file 14, creates a row, and enters the information therein.

While FIG. 2B illustrates an example Power page according to various embodiments, the layout and operation of a Signal page (not shown) may be considered to be very similar. An example difference between a Power page and a Signal page is that the sub-circuits described in the Signal page may include parameters (such as operating frequency) that are more useful to signal modeling than to power modeling. However, the features described above for retrieving and displaying information are the same for both the Signal page and Power page.

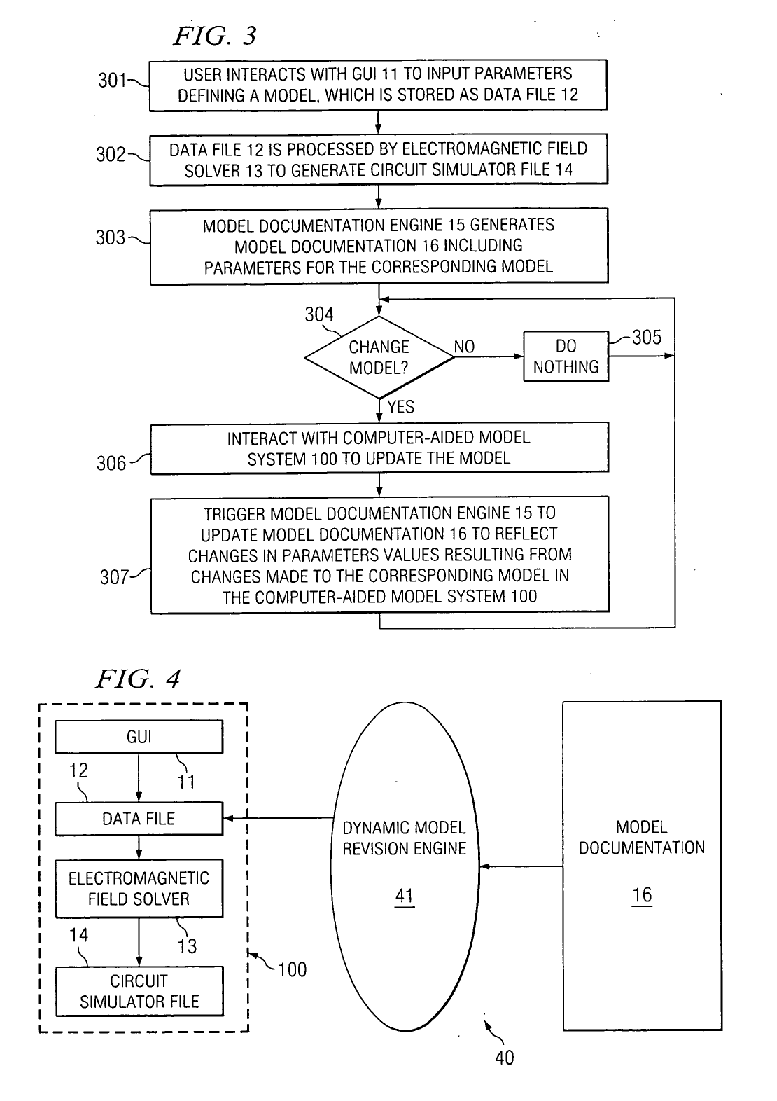

Turning to FIG. 3, an operational flow of one embodiment of FIG. 1 is shown. In this example, in operational block 301, a user interacts with GUI 11 of computer-aided modeling system 100 to input parameters defining a model, which results in data file 12. In operational block 302, data file 12 is processed by electromagnetic field solver 13 to generate circuit simulator file 14. In block 303, model documentation engine 15 generates model documentation 16 including parameters for the corresponding model.

In block 304 a determination is made whether any changes are desired for the model on the computer-aided modeling system 100. If no changes are desired, then no further action is taken by model documentation engine 15 in block 305, and operation returns to block 304. If a user desires to make changes to the model, then operation advances to block 306 whereat the user interacts with computer-aided modeling system 100 to update/change the model in the desired manner. In block 307, model documentation engine 15 is triggered to update model documentation 16 to reflect any changes in the parameter values resulting from the changes made in block 306 to the corresponding model in the computer-aided modeling system 100. As described above, model documentation engine 15 may be triggered by the user (e.g., by the user activating load value buttons 234 and 241 included in the model documentation file 16. Alternatively, model documentation engine 15 may be triggered to update the parameter values in the documentation file 16 periodically or based on the occurrence of some other triggering event (e.g., based on a user editing data file 12 or based on circuit simulator file 14 changing for a model). Operation then returns to block 304 to determine whether the user desires to make further changes to the model.

Turning to FIGS. 4 and 5, another example embodiment is shown in which a dynamic model revision engine is implemented to generate changes in a model designed in a computer-aided modeling system responsive to editing of the model's corresponding documentation file. FIG. 4 shows an example embodiment of a system 40. As with system 10 of FIG. 1, system 40 includes a computer-aided modeling system 100 for modeling an object, such as an electrical system. Again, such computer-aided modeling system 100 includes GUI 11 for interacting with a user to receive input information for defining a model, which generates data file 12, and electromagnetic field solver 13 processes data file 12 to generate circuit simulator file 14.

Further included in system 40 is dynamic model revision engine 41. Dynamic model revision engine 41 includes logic (software and/or hardware) that is operable to maintain the corresponding model in computer-aided modeling system 100 (e.g., data file 12) consistent with its corresponding model documentation file 16. More specifically, dynamic model revision engine 41 is operable to update the model in the computer-aided modeling system 100 responsive to changes made in the model's corresponding documentation file 16. For instance, responsive to a user changing parameter value(s) in documentation file 16, dynamic model revision engine 41 is operable to update data file 12 with the changed parameter values. As an example, any one or more of the parameter values in section 223 of FIG. 2B, such as Pitch X/Y 227, Width/Radius 228, Strip Height 229, Length 230, rho 231, and Er 232, may be changed by a user in model documentation file 16, and dynamic model revision engine 41 updates data file 12 to accurately reflect the changed parameter values. Circuit simulator file 14 is then produced through operation of electromagnetic field solver 13.

Turning to FIG. 5, an operational flow of one embodiment of FIG. 4 is shown. In this example, in operational block 501, a model is generated in computer-aided modeling system 100. For instance, a user may interact with GUI 11 of computer-aided modeling system 100 to input parameters defining a model, which results in data file 12, and such data file 12 may be processed by electromagnetic field solver 13 to generate circuit simulator file 14. In block 502 model documentation 16 is generated for the model, documenting parameters of the model. As discussed above with FIGS. 1-3, in certain embodiments model documentation engine 15 may generate such model documentation 16.

In block 502 a determination is made whether any changes are desired for the model documentation 16. If no changes are desired, then no action is taken by dynamic model revision engine 41 in block 504, and operation returns to block 503. If a user desires to make changes to the model documentation 16, then operation advances to block 505 whereat the user interacts with model documentation 16 (e.g., via a suitable interface, such as a spreadsheet application program, word processor program, etc.) to change the model documentation in the desired manner. In block 506, dynamic model revision engine 41 is triggered to update the corresponding model in the computer-aided modeling system 100 (e.g., data file 12) to reflect any changes in the parameter values resulting from the changes made in block 505 to the corresponding model documentation 16. As described above, dynamic model revision engine 41 may be triggered by the user (e.g., by the user activating an “update model” button included in the model documentation file 16). Alternatively, dynamic model revision engine 41 may be triggered to update the parameter values in the corresponding model (e.g., in data file 12) periodically or based on the occurrence of some other triggering event. Operation then returns to block 503 to determine whether the user desires to make further changes to the model documentation 16.

Turning to FIGS. 6-7 an example embodiment is shown in which a sub-circuit generation engine is implemented to generate a sub-circuit file for use by a larger circuit model. FIG. 6 shows an example embodiment of a system 60. Included in system 60 is sub-circuit generation engine 61. Sub-circuit generation engine 61 includes logic (software and/or hardware) that is operable to generate sub-circuit file(s) 62 (for use by a larger circuit model, such as a SPICE deck) from information included in model documentation file 16 for defining such sub-circuit file(s) 62. For instance, responsive to being triggered (e.g., by a user), sub-circuit generation engine 61 is operable to generate such sub-circuit file 62 from the information in documentation file 16 by retrieving the information and creating a file wherein the information is incorporated such that the file is essentially a circuit simulation file reformatted to possibly include additional notes or variables and to specifically fit a corresponding application (such as a SPICE deck). Additional notes included in sub-circuit file 62 may be documentation notes 240, retrieved from documentation file 16. An example of an additional variable that may be included in sub-circuit file 62 is a multiplication factor to be applied to a resistance value, such that a designer may decrease the resistance of a sub-circuit (by decreasing the value of the multiplication factor) to indicate that parallel components have been added in the sub-circuit. Such additional variable may be retrieved from documentation file 16 or generated by sub-circuit generation engine 61 upon instructions from a designer. Sub-circuit generation engine 61, in this example, then saves sub-circuit file 62 in a directory with other sub-circuit files corresponding to the same larger circuit model.

FIG. 7A shows an example operational flow for generating a sub-circuit file in accordance with one embodiment. In operational block 701, model documentation (e.g., model documentation 16 of FIGS. 1 and 6) that includes design parameters corresponding to a model designed in a computer-aided modeling system (e.g., computer-aided modeling system 100 of FIG. 1) is edited. In operational block 702, a sub-circuit generation engine (e.g., engine 61 of FIG. 6) generates a sub-circuit file (e.g., sub-circuit file 62 of FIG. 6) defined by the model documentation. In this example embodiment, the generated sub-circuit file is usable by a second model.

Turning to FIG. 7B, operational flow 700 of one embodiment of generating a sub-circuit file accordance with the example of FIG. 6 is shown. In block 710, sub-circuit generation engine 61 is triggered to generate sub-circuit file 62. Engine 61, in at least one embodiment, is triggered by a user by activating an “update sub-circuit” button in documentation file 16. In alternate embodiments, engine 61 may be triggered automatically by means including, but not limited to, periodic triggering and triggering in response to a change in documentation file 16. In block 720 engine 61 finds parameters to describe the particular sub-circuit of the dynamic model from model documentation file 16. The parameters include, but are not limited to sub-circuit name 237, RC2 values from section 239 (of FIG. 2B), sub-circuit descriptions from section 240 (of FIG. 2B) a directory date from section 233 (of FIG. 2B) and other parameters (not shown). Any helpful parameter associated with the particular sub-circuit in documentation 16 may be compiled in sub-circuit file 62 in a variety of embodiments. In block 730, engine 61 compiles the parameters into a single file in useable format thereby creating sub-circuit file 62. In at least one embodiment, the useable format for sub-circuit file 62 is a SPICE file, so that a larger circuit model is made up of smaller sub-circuit files which can be simulated via SPICE.

The functionality of any combination the engines described in FIGS. 1-7 may be implemented in certain embodiments. For instance, an example system 80 that includes the model documentation engine 15 of FIGS. 1-3, the dynamic model revision engine 41 of FIGS. 4-5, and the sub-circuit generation engine 61 of FIGS. 6-7B is shown in FIG. 8. Accordingly, system 80 is operable to maintain full homogeneity between a model on computer-aided modeling system 100 and its corresponding documentation 16. For instance, if a user makes a change to a model in computer-aided modeling system 100, model documentation engine 15 is operable to edit the corresponding model documentation 16 for such model in the manner described above with FIGS. 1-3. For example, after changing the model in computer-aided modeling system 100 (e.g., after editing data file 12 and processing such data file 12 with electromagnetic field solver 13 to generate circuit simulator file 14), the user may interact with model documentation file 16 to trigger loading the new values from the changed model in the model-documentation file 16 (e.g., the user may activate the load values tab buttons 234 and/or 241 in the example model documentation file 16 of FIG. 2B), which causes the model documentation file 16 to be updated with the new parameter values for the changed model. Thus, the model documentation 16 is maintained consistent (or homogeneous) with its corresponding model in the computer-aided modeling system 100.

Further, if a user makes a change to the documentation 16 of a model, dynamic model revision engine 41 is operable to revise the corresponding model in computer-aided modeling system 100 to reflect the changes made to the documentation file 16 in the manner described above with FIGS. 4-5. Thus, the model in the computer-aided modeling system 100 is maintained consistent (or homogeneous) with its corresponding documentation 16.

Additionally, sub-circuit generation engine 61 is operable to generate sub-circuit file 62 for use by a larger circuit model in the manner described above with FIGS. 6-7. Thus, when the model in the computer-aided modeling system 100 and corresponding documentation 16 are homogeneous, sub-circuit generation engine 61 may be triggered to generate sub-circuit files 62 needed for a larger circuit model.

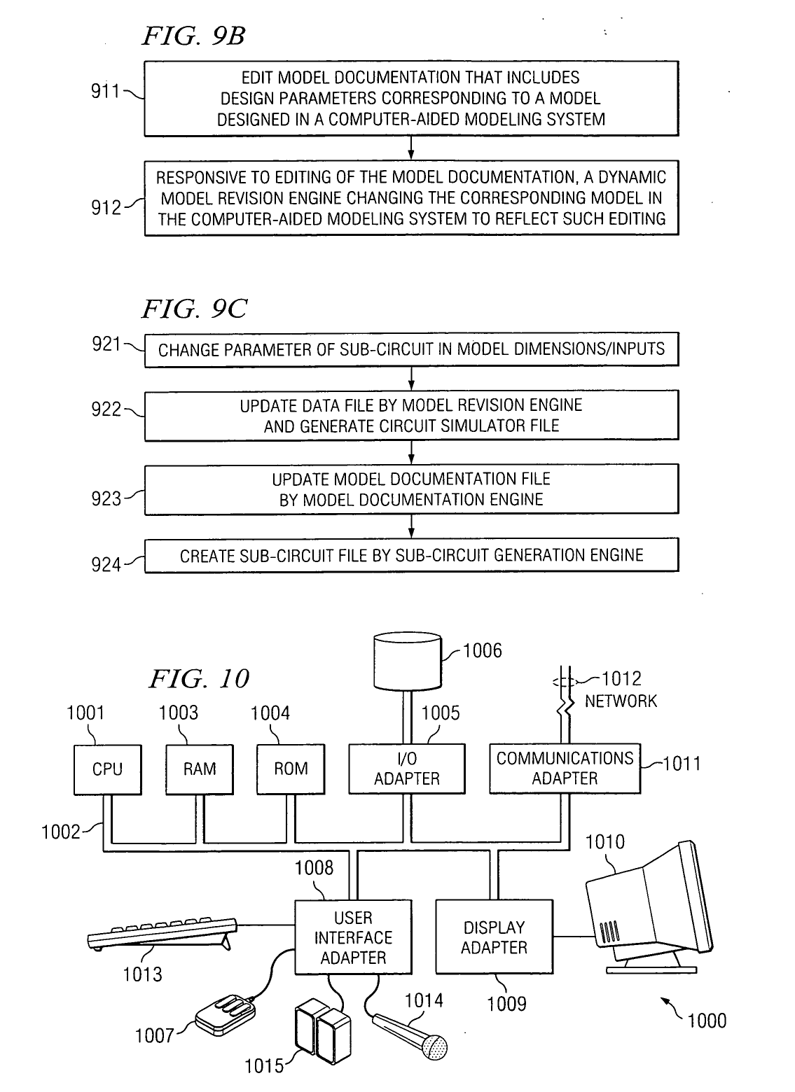

Turning to FIGS. 9A and 9B, operational flows according to various embodiments of a system for maintaining homogeneity between a model in a computer-aided modeling system and its corresponding model documentation are shown. A system may be implemented to include any one or more (e.g., any combination) of the functionality described in connection with FIGS. 9A and 9B. In the example embodiment of FIG. 9A, a model documentation engine 15 receives (in operational block 901) information from a computer-aided modeling system 100, wherein the information includes design parameters corresponding to a model designed in the computer-aided modeling system 100. In operational block 902, the model documentation engine 15 updates model documentation 16 to reflect the design parameters for the model.

In the example embodiment of FIG. 9B, model documentation 16 that includes design parameters corresponding to a model designed in a computer-aided modeling system 100 is edited by a user in operational block 911. In operational block 912, responsive to the editing of the model documentation 16, a dynamic model revision engine 41 changes the corresponding model in the computer-aided modeling system 100 to reflect such editing. For instance, as described above, a user may edit various parameters of a model in the model's documentation 16, and dynamic model revision engine 41 changes the corresponding model to have the edited parameters of the model's documentation 16.

FIG. 9C shows an operational flow according to various embodiments of a system for creating sub-circuit files. In operational block 921, a designer changes a parameter (such as dielectric constant, Er 232) of a sub-circuit (such as core_section_a) in a directory 225 in model dimensions/inputs 161 of documentation file 16. In operational block 922, the designer then updates data file 12 in computer-aided modeling system 100 by activating an “update model” button (not shown) in documentation file 16, which triggers model revision engine 41. After data file 12 is updated, electromagnetic field solver 13 generates circuit simulator file 14, which describes a simulation of the sub-circuit having the changed parameter In operational block 923, model documentation engine 15 is triggered by a user by, for example, activating tab 241 (note that in this case, only circuit elements 162 will be changed in documentation file 16 because model dimensions/inputs 161 already contains the user modification). This triggering updates model documentation file 16. In operational block 924, the user triggers sub-circuit generation engine 61 by, for example, activating an “update sub-circuit” tab (not shown). Sub-circuit generation engine 61 then creates sub-circuit file 62, which is a new sub-circuit file incorporating the change to the parameter.

When implemented via computer-executable instructions, various elements of the embodiments of the above-described engines for maintaining homogeneity between a model in a computer-aided modeling system and its corresponding documentation are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 10 illustrates an example computer system 1000 adapted according to an embodiment for implementing one or more of the above-described engines. For instance, computer system 1000 provides an example system on which computer-aided modeling system 100 and/or one or more of the above-described engines may be implemented. Central processing unit (CPU) 1001 is coupled to system bus 1002. CPU 1001 may be any general purpose CPU. Embodiments described above are not restricted by the architecture of CPU 1001 as long as CPU 1001 supports the inventive operations as described herein. CPU 1001 may execute the various logical instructions according to embodiments described above. For example, CPU 1001 may execute machine-level instructions according to the exemplary operational flows described above in conjunction with FIGS. 3, 5, 7A-7B, and 9A-9C.

Computer system 1000 also includes random access memory (RAM) 1003, which may be SRAM, DRAM, SDRAM, or the like. Computer system 1000 further includes read-only memory (ROM) 1004 which may be PROM, EPROM, EEPROM, or the like. RAM 1003 and ROM 10041 hold user and system data and programs.

Computer system 1000 also includes input/output (I/O) adapter 1005, communications adapter 1011, user interface adapter 1008, and display adapter 1009. I/O adapter 1005, user interface adapter 1008, and/or communications adapter 1011 may, in certain embodiments, enable a user to interact with computer system 1000 in order to input information, such as via GUI 11 and/or via a user interface for an application presenting a model documentation file 16, such as the examples shown in FIGS. 2A and 2B. User interface adapter 1008 couples user input devices, such as keyboard 1013, pointing device 1007, and microphone 1014 and/or output devices, such as speaker(s) 1015 to computer system 1000. Display adapter 1009 is driven by CPU 1001 to control the display on display device 1010 to, for example, display GUI 11 and/or a user interface of an application (e.g., a spreadsheet program or a word processing program) presenting a model documentation file 16, such as the examples shown in FIGS. 2A and 2B.

I/O adapter 1005 corrects to storage device(s) 1006, such as one or more of hard drive, compact disc (CD) drive, floppy disk drive, tape drive, etc. to computer system 1000. The storage devices may be utilized when RAM 1003 is insufficient for the memory requirements associated with storing data for computer-aided modeling system 100 and/or one or more of engines 15, 41, and 61, such as model documentation file 16. Communications adapter 1011 is adapted to couple computer system 1000 to a communication network 1012, such as the Internet or other wide area network (WAN), a local area network (LAN), a telecommunication network, a wireless network, or any combination thereof, as examples. Thus, in certain embodiments, a user may interact with computer-aided modeling system 100 and/or parameter model documentation file 16 from a remote computer via such communication network 1012. Further, in certain embodiments, model documentation file 16 may be stored at a location remote to a computer on which computer-aided modeling system 100 and/or engines 15, 41, and 61 are executing, and one or more of the engines implemented may access model documentation file 16 via communication network 1012. Similarly, in certain embodiments, one or more of engines 15, 41, and 61 may be executing on a computer (such as computer system 1000 of FIG. 10) that is remote to a computer on which computer-aided modeling system 100 is executing, and one or more of the engines implemented may communicatively access the computer-aided modeling system 100 via communication network 1012.

Embodiments described above are not limited to the architecture of example system 1000. For example, any suitable processor-based device may be utilized, including without limitation personal computers, laptop computers, computer workstations, and multi-processor servers. Moreover, embodiments of one or more of engines 15, 41, and 61 may be implemented on application specific integrated circuits (ASICs) or very large scale integrated (VLSI) circuits. In fact, persons of ordinary skill in the art may utilize any number of suitable structures capable of executing logical operations according to the embodiments described above.

1. A system comprising logic for maintaining homogeneity between a model of an object designed in a computer-aided modeling system and corresponding parameter information for the model included in a model documentation file.

2. The system of claim 1 wherein said logic comprises:
logic operable to determine said corresponding parameter information for the model and update said model documentation file to include said corresponding parameter information for the model.

3. The system of claim 1 wherein the model documentation comprises a trigger object that when activated by a user triggers the logic to update the model documentation with the corresponding parameter information for the model.

4. The system of claim 3 wherein said trigger object comprises an input button presented on a display.

5. The system of claim 1 wherein said logic comprises:
logic operable to update the model in the computer-aided modeling system to reflect changes made to the model documentation file.

6. The system of claim 1 wherein said logic further comprises:
logic operable to use information in the model documentation to generate a sub-circuit file for use in a second object model.

7. The system of claim 1 wherein the object comprises an electrical system.

8. A system comprising:
a computer-aided modeling system that is operable to allow a user to design a model of an object; and
a model documentation engine that is operable to update model documentation for a model designed in the computer-aided modeling system to include design parameters corresponding to the model in the computer-aided modeling system.

9. The system of claim 8 wherein the model documentation engine is operable to retrieve parameter information from the computer-aided modeling system for the model and use the parameter information to update the design parameters in the model documentation.

10. The system of claim 8 wherein the object comprises an electrical system.

11. The system of claim 10 wherein the computer-aided modeling system comprises:
a program for presenting a graphical user interface for receiving parameters for the model as input and generating a data file for the model; and
an electromagnetic field solver program for processing the generated data file to generate a circuit simulator file.

12. The system of claim 8 wherein the model documentation comprises a trigger object that when activated by a user triggers the model documentation engine to update the model documentation with the design parameters corresponding to the model in the computer-aided modeling system.

13. The system of claim 12 wherein said trigger object comprises an input button presented on a display.

14. The system of claim 8 further comprising:
a dynamic model revision engine that is operable to update the model in the computer-aided modeling system to reflect changes made to the design parameters in the model documentation.

15. The system of claim 8 further comprising:
a sub-circuit generation engine that is operable to use information in the model documentation to generate a sub-circuit file for use in a second object model.

16. A method comprising:
receiving at a model documentation engine information from a computer-aided modeling system, said information including design parameters corresponding to a model designed in the computer-aided modeling system; and
updating, by said model documentation engine, model documentation for said model to reflect the design parameters for the model.

17. The method of claim 16 wherein said model documentation comprises a graphical user interface having a button operable to trigger said model documentation engine.

18. The method of claim 17 wherein receiving comprises triggering by said button the model documentation engine into activity.

19. The method of claim 16 further comprising:
generating, by a sub-circuit generation engine, a sub-circuit file incorporating said design parameters for use by a second model.

20. A system comprising:
a computer-aided modeling system that is operable to allow a user to design a model of an object; and at least one engine for communicating with the computer-aided modeling system for performing at least one of the following operations:
(a) updating model documentation to include parameters corresponding to a model designed in the computer-aided modeling system, and
(b) causing the computer-aided modeling system to change the corresponding model to reflect such updating.

21. The system of claim 20 wherein the causing the computer-aided modeling system to change the model is responsive to the updating of the model documentation corresponding to the model designed in the computer-aided modeling system.

22. The system of claim 20 wherein the causing the computer-aided modeling system to change the model is responsive to a triggering by a user.

23. The system of claim 20 wherein the object is an electronic device.

24. The system of claim 20 further comprising:
a sub-circuit generation engine that is operable to use one or more of the parameters in the model documentation to generate a sub-circuit file for use in a second model.

25. A method comprising:
editing model documentation that includes design parameters corresponding to a model designed in a computer-aided modeling system; and
changing by a dynamic model revision engine the corresponding model in the computer-aided modeling system to reflect such editing.

26. The method of claim 25 wherein the changing the model is responsive to the editing of the model documentation.

27. The method of claim 25 wherein the editing the model documentation comprises manually entering changes of the design parameters into a model dimensions/input portion of the model documentation.

28. The method of claim 27 wherein the changing the model comprises inputting into a data file one or more of the design parameters and translating the contents of the data file into a circuit simulator file.

29. The method of claim 28 further comprising:
updating by a model documentation engine a circuit elements portion of the model documentation to reflect contents of the circuit simulator file.

30. The method of claim 29 further comprising:
generating a sub-circuit file to reflect the updating of the circuit elements portion.

31. The method of claim 25 wherein the model is a representation of an integrated circuit.

32. The method of claim 31 wherein the design parameters include power parameters and signal parameters.

33. A system comprising:
means for designing a model of an object;
means for communicating with the designing means and editing a model documentation for a model designed in the designing means to include one or more parameters corresponding to the model; and
means for changing said model designed in the designing means.

34. The system of claim 33 further comprising:
means for autonomously generating said model documentation that includes one or more parameters corresponding to said model designed in the designing means.

35. The system of claim 33 further comprising:
means for determining at least one parameter of a model designed in the designing means.

36. The system of claim 33 wherein the means for changing said model are responsive to editing of the model documentation.

37. The system of claim 33 further comprising:
means for generating a sub-circuit file from at least one of said parameters.

38. A method comprising:
editing model documentation that includes design parameters corresponding to a model designed in a computer-aided modeling system; and
generating by a sub-circuit generation engine a sub-circuit file defined by the model documentation, wherein the generated sub-circuit file is usable by a second model.

39. The method of claim 38 wherein the generating is responsive to the editing of the model documentation.

40. The method of claim 38 further comprising:
saving the sub-circuit file to a directory with other sub-circuit files which correspond to the second model.

41. The method of claim 38 wherein the sub-circuit file is a circuit simulator file formatted to include one or more notes and one or more design parameters.

42. The method of claim 41 wherein the sub-circuit file is a SPICE file, and wherein the second model comprises a SPICE deck.
